(19) United States
(12) Patent Application Publication
(10) Pub. No.: US 2023/0021841 A1
(43) Pub. Date: Jan. 26, 2023

(54) Sheets Comprising Encapsulated Fragrance Compositions and Methods to Manufacture Same

(71) Applicant: FIRMENICH SA, Satigny (CH)

(72) Inventors: Michael PISTON, Plainsboro, NJ (US); Theodore ANASTASIOU, Plainsboro, NJ (US)

(21) Appl. No.: 17/757,426

(22) PCT Filed: Dec. 10, 2020
(86) PCT No.: PCT/EP2020/085566

§ 371 Date: Jun. 15, 2022

(30) Foreign Application Priority Data
Feb. 24, 2020 (EP) 20158941.3

(51) Int. Cl. C11D 17/04; C11D 11/00; C11D 3/00; C11D 3/50; C11D 3/37

(52) U.S. Cl. CPC C11D 17/047; C11D 11/0017; C11D 3/001; C11D 3/505; C11D 3/3703

(57) ABSTRACT

Described herein is an article of manufacture and a method of manufacturing said article, where the article of manufacture includes: a substrate including a webbing; and a varnish layer including an encapsulated fragrance composition applied to at least one surface of the substrate.

### FIELD OF THE INVENTION

The present disclosure relates to the field of perfumery. In particular, the present disclosure provides compositions and methods for manufacturing fabric softener or dryer sheets comprising encapsulated fragrance compositions.

### BACKGROUND

A well-known commercial product in the laundry care industry is the fabric softener or dryer sheet. In use, the consumer typically uses at least one sheet in the drying cycle of the laundering process. The fabric softener or dryer sheets generally include a substrate material, such as a web, wherein the substrate carries one or more ingredients to impart desired benefits to the clothing. These ingredients may include, for example, perfumes, anti-static agents, dye transfer inhibitors, whitening agents, enzymes, stain repellents, wrinkle reducing agents, fabric softener agents, and the like.

In a typical process to manufacture fabric softener or dryer sheets, a large role of the web material is guided at high speeds through various coating, smoothing and drying/cooling steps wherein one or more ingredients are applied to the web. However, traditional manufacturing methods often result in an ineffective delivery of fragrance to fabrics dried in automatic clothes dryers.

The present invention relates to compositions which may be applied to articles of manufacture to provide improved fragrance delivery to fabrics dried in automatic clothes dryers.

### SUMMARY

In one aspect, the present disclosure provides a method, comprising the steps of:
a) providing a rolled substrate comprising a webbing;
b) unrolling a portion of the substrate; and
c) applying a varnish comprising an encapsulated fragrance composition to the unrolled portion of the substrate in a first coating step.

In a further aspect, the method further comprises a step of adding at least one agent selected from the group consisting of: an at least one anti-static agent, at least one dye transfer inhibitor, at least one whitening agent, an at least one enzyme, at least one stain repellent, at least one wrinkle reducing agent, and at least one fabric softener agent to the unrolled portion of the substrate in a subsequent coating step.

In a further aspect, the method further comprises a step of adding a protective overprint layer on top of the varnish layer in a subsequent coating step.

In one aspect, the present disclosure provides an article of manufacture, wherein the article of manufacture comprises:
a) a substrate comprising a webbing; and
b) a varnish layer containing an encapsulated fragrance composition applied to at least one surface the substrate.

In a further aspect, the article of manufacture further comprises a protective overprint layer on top of the varnish layer containing an encapsulated fragrance composition applied to at least one surface the substrate.

In a further aspect, the article of manufacture further comprises at least one agent selected from the group consisting of: an at least one anti-static agent, at least one dye transfer inhibitor, at least one whitening agent, an at least one enzyme, at least one stain repellent, at least one wrinkle reducing agent, and at least one fabric softener agent.

In a further aspect, the substrate comprises a non-woven webbing.

In a further aspect, the article of manufacture is a dryer sheet.

In a further aspect, the article of manufacture is a wipe.

### BRIEF DESCRIPTION OF THE FIGURES

While the specification concludes with claims particularly pointing out and distinctly claiming the invention, it is believed that the invention will be better understood from the following description of the accompanying figures wherein:

FIG. 1 shows the intensity of fragrance perceived by subjects in a sensory test panel from dryer sheets manufactured by a method according to an aspect presented herein, compared to the intensity of fragrance perceived by subjects in a sensory test panel from dryer sheets manufactured by a conventional method.

FIG. 2 shows the results of a sensory panel evaluating the performance of dryer sheets manufactured by a method according to an aspect presented herein, compared to a commercially available dryer sheet (left two columns). Error calculated by confidence intervals (95%). The dryer sheets manufactured by a method according to an aspect presented herein were dryer sheets comprising microcapsules containing perfume oil A (two columns second from left), perfume oil B (two columns second from right), and perfume oil C (right two columns).

FIG. 3 shows the results of a sensory panel evaluating the performance of dryer sheets manufactured by a method according to an aspect presented herein, compared to a commercially available dryer sheet (left two columns). Error calculated by confidence intervals (95%). The dryer sheets manufactured by a method according to an aspect presented herein were dryer sheets comprising microcapsules containing perfume oil A (two columns second from left), perfume oil B (two columns second from right),

FIG. 4 show the results of the effects of washing on the deposition of wax and fragrance capsules on a commercially available dryer sheet.

FIG. 5 show the results of the effects of washing on the deposition of wax and fragrance capsules on dryer sheets manufactured by a method according to an aspect presented herein.

### DETAILED DESCRIPTION

In the following description, reference is made to specific embodiments which may be practiced, which is shown by way of illustration. These embodiments are described in detail to enable those skilled in the art to practice the invention described herein, and it is to be understood that other embodiments may be utilized and that logical changes may be made without departing from the scope of the aspects presented herein. The following description of example embodiments is, therefore, not to be taken in a limited sense, and the scope of the various aspects presented herein is defined by the appended claims.

The Abstract is provided to comply with 37 C.F.R. § 1.72(b) to allow the reader to quickly ascertain the nature and gist of the technical disclosure. The Abstract is submitted with the understanding that it will not be used to interpret or limit the scope or meaning of the claims.

The Method: In some aspects, the sheets comprising the encapsulated fragrance composition are coated with the encapsulated fragrance composition and optionally, at least one agent selected from the group consisting of: an at least one anti-static agent, at least one dye transfer inhibitor, at least one whitening agent, an at least one enzyme, at least one stain repellent, at least one wrinkle reducing agent, and at least one fabric softener agent. In one aspect, the rolled substrate comprising a webbing may be coated with the encapsulated fragrance composition and optionally, at least one agent selected from the group consisting of: an at least one anti-static agent, at least one dye transfer inhibitor, at least one whitening agent, an at least one enzyme, at least one stain repellent, at least one wrinkle reducing agent, and at least one fabric softener agent by being sequentially passed over applicator rollers coated with the encapsulated fragrance composition and optionally, at least one agent selected from the group consisting of: an at least one anti-static agent, at least one dye transfer inhibitor, at least one whitening agent, an at least one enzyme, at least one stain repellent, at least one wrinkle reducing agent, and at least one fabric softener agent.

In some aspects, a protective overprint layer may also be added by passing the rolled substrate comprising a webbing over a roller coated with the protective overprint layer.

In one aspect, the present disclosure provides a method, comprising the steps of:
a) providing a rolled substrate comprising a webbing;
b) unrolling a portion of the substrate; and
c) applying a varnish comprising an encapsulated fragrance composition to the unrolled portion of the substrate in a first coating step.

In one aspect, the varnish comprising an encapsulated fragrance composition is applied to the unrolled portion of the substrate via flexographic printing. In one such embodiment, an anilox roll is coated with a slurry of the varnish comprising an encapsulated fragrance composition, and the unrolled portion of the substrate is passed over the anilox roll at a speed ranging from 60 to 105 ft/min, wherein the slurry is deposited to a surface of the unrolled portion of the substrate. The speed can be increased to tolerances allowed by the machine directional strength of the non-woven.

One of ordinary skill in the art can readily appreciate that the amount of the slurry that is deposited to a surface of the unrolled portion of the substrate may be varied by altering several parameters, such as, for example, the speed at which the unrolled portion of the substrate is passed over the anilox roll, the transfer volume of the anilox roll, the number, size, and geometry of the anilox cells, and the like.

In one aspect the transfer volume of the anilox roll is from 1 to 20 billion cubic microns per square inch.

In a further aspect, the method further comprises a step of adding a protective overprint layer on top of the varnish layer in a subsequent coating step. In one aspect, the protective overprint layer comprises a PEG solution. In some aspects, the PEG solution is at a concentration of 60% in water.

In a further aspect, the method further comprises a step of adding at least one agent selected from the group consisting of: at least one anti-static agent, at least one dye transfer inhibitor, at least one whitening agent, at least one enzyme, at least one stain repellent, at least one wrinkle reducing agent, and at least one fabric softener agent to the unrolled portion of the substrate in a subsequent coating step. Non-limiting examples of the at least one agent are disclosed in U.S. Pat. Nos. 5,246,603 and 6,297,210.

The Substrate: Suitable materials which can be used as a substrate include, sponges, paper, and woven and non-woven cloth, and the like. In one aspect the substrate is a non-woven substrate. As used herein, non-woven substrates may comprise bonded fibrous or filamentous products having a web or carded fiber structure (where the fiber strength is suitable to allow carding), or, alternatively, may comprise fibrous mats in which the fibers or filaments are distributed haphazardly or in random array (i.e. an array of fibers in a carded web wherein partial orientation of the fibers is frequently present, as well as a completely haphazard distributional orientation), or substantially aligned. The fibers or filaments may be natural (e.g. wool, silk, jute, hemp, cotton, linen, sisal, or ramie) or synthetic (e.g. rayon, cellulose ester, polyvinyl derivatives, polyolefins, polyamides, or polyesters).

The substrate may be configured to provide a desired physical property, such as, for example, absorbency, tensile strength, thickness and the like. For example, and without intending to be limited to any particular theory, a desired absorbency may be achieved by building up the thickness of the cloth, i.e., by superimposing a plurality of carded webs or mats to a thickness adequate to obtain the necessary absorbent properties, or by allowing a sufficient thickness of the fibers to deposit on the screen.

The non-woven substrate may be made by any method readily selected by one of skill in the art. Examples include the methods disclosed in U.S. Pat. No. 5,246,603.

The rolled substrate comprising the encapsulated fragrance may subsequently be processed to provide articles of manufacture such as, for example, wipes, tissues, dryer sheets and the like.

Accordingly, in one aspect, the rolled substrate comprising the encapsulated fragrance is further processed to provide an article of manufacture configured to condition fabric in an automatic clothes dryer. In one such aspect, the article of manufacture is a dryer sheet.

Examples of dryer sheets suitable for manufacture according to the methods disclosed herein are the dryer sheets disclosed in U.S. Pat. No. 5,246,603. Another example of dryer sheets suitable for manufacture according to the methods disclosed herein are the dryer sheets disclosed in U.S. Pat. No. 6,297,210.

Alternatively, in one aspect, the rolled substrate comprising the encapsulated fragrance is further processed to provide an article of manufacture configured to deliver fragrance to a surface. In one such aspect, the article of manufacture is a wipe.

Examples of wipes suitable for manufacture according to the methods disclosed herein are the wipes disclosed in U.S. Pat. No. 7,285,520. Another example of wipes suitable for manufacture according to the methods disclosed herein are the wipes disclosed in U.S. Pat. No. 5,863,663.

The Encapsulated Fragrance Composition: In some aspects, a fragrance composition is encapsulated via a method comprising the following general steps: first, an oil-in-water emulsion or a water-in-oil emulsion is prepared with monomers or polymers soluble in oil phase (such as polyisocyanates) and with polymers soluble in water phase (such as polyamine, polyol). Then, under specific conditions (temperature, pH, and the like) those polymers react together at the oil-water interface to form a polymeric shell. An aqueous core-shell microcapsule slurry is thus obtained, wherein the fragrance composition is contained within the core of the microcapsules.

Without intending to be limited to any particular theory, the nature of the shell of the microcapsules depends on the nature of the momomers or polymers present respectively in the oil phase and in the water phase. For example, a polyurea shell is obtained when a polyisocyanate reacts with a polyamine whereas a polyurethane shell is obtained when a polyisocyanate reacts with a polyol.

Processes for producing such microcapsules are widely disclosed in the prior art. Examples of processes for the preparation of polyurea- and polyureathane-based microcapsule slurries are for instance described in WO2007/004166, EP 2300146 or EP2579976.

The material encapsulating the fragrance composition can be microcapsules which have been widely described in the prior art, preferably of the core-shell type with a polymeric shell.

The nature of the polymeric shell from the microcapsules of the present disclosure can vary. As non-limiting examples, the shell can be aminoplast-based, polyurea-based or polyurethane-based. The shell can also be hybrid, namely organic-inorganic such as a hybrid shell composed of at least two types of inorganic particles that are cross-linked, or yet a shell resulting from the hydrolysis and condensation reaction of a polyalkoxysilane macro-monomeric composition.

According to an aspect, the shell comprises an aminoplast copolymer, such as melamine-formaldehyde or urea-formaldehyde or cross-linked melamine formaldehyde or melamine glyoxal.

According to another aspect the shell is polyurea-based made from, for example but not limited to isocyanate-based monomers and amine-containing crosslinkers such as guanidine carbonate and/or guanazole. Certain polyurea microcapsules comprise a polyurea wall which is the reaction product of the polymerisation between at least one polyisocyanate comprising at least two isocyanate functional groups and at least one reactant selected from the group consisting of an amine (for example a water soluble guanidine salt and guanidine); a colloidal stabilizer or emulsifier; and an encapsulated perfume. However, the use of an amine can be omitted.

According to another embodiment, the microcapsules have a shell as described in WO2019243426.

According to a particular aspect, the colloidal stabilizer includes an aqueous solution of between 0.1% and 0.4% of polyvinyl alcohol, between 0.6% and 1% of a cationic copolymer of vinylpyrrolidone and of a quaternized vinylimidazol (all percentages being defined by weight relative to the total weight of the colloidal stabilizer). According to another aspect, the emulsifier is an anionic or amphiphilic biopolymer, which may be, in one aspect, chosen from the group consisting of gum Arabic, soy protein, gelatin, sodium caseinate and mixtures thereof.

According to another aspect, the shell is polyurethane-based made from, for example but not limited to polyisocyanate and polyols, polyamide, polyester, etc.

According to another embodiment, the microcapsules have a polymeric shell resulting from complex coacervation wherein the shell is possibly cross-linked such as described in WO2014044840.

The preparation of an aqueous dispersion/slurry of core-shell microcapsules is well known by a skilled person in the art. In one aspect, the microcapsule wall material may comprise any suitable resin and especially including melamine, glyoxal, polyurea, polyurethane, polyamide, polyester, etc. Suitable resins include the reaction product of an aldehyde and an amine, suitable aldehydes include, formaldehyde and glyoxal. Suitable amines include melamine, urea, benzoguanamine, glycoluril, and mixtures thereof. Suitable melamines include, methylol melamine, methylated methylol melamine, imino melamine and mixtures thereof. Suitable ureas include, dimethylol urea, methylated dimethylol urea, urea-resorcinol, and mixtures thereof. Suitable materials for making may be obtained from one or more of the following companies Solutia Inc. (St Louis, Mo. U.S.A.), Cytec Industries (West Paterson, N.J. U.S.A.), Sigma-Aldrich (St. Louis, Mo. U.S.A.).

According to one aspect, the microcapsule is a one-shell aminoplast core-shell microcapsule obtainable by a process comprising the steps of:
1) admixing a perfume oil with at least a polyisocyanate having at least two isocyanate functional groups to form an oil phase;
2) dispersing or dissolving into water an aminoplast resin and optionally a stabilizer to form a water phase;
3) preparing an oil-in-water dispersion, wherein the mean droplet size is comprised between 1 and 100 microns, by admixing the oil phase and the water phase;
4) performing a curing step to form the wall of said microcapsule; and
5) optionally drying the final dispersion to obtain the dried core-shell microcapsule.

According to one aspect, the core-shell microcapsule is a formaldehyde-free capsule. A typical process for the preparation of aminoplast formaldehyde-free microcapsules slurry comprises the steps of
1) preparing an oligomeric composition comprising the reaction product of, or obtainable by reacting together:
   a. a polyamine component in the form of melamine or of a mixture of melamine and at least one C₁-C₄ compound comprising two NH2 functional groups;
   b. an aldehyde component in the form of a mixture of glyoxal, a C₄₋₆ 2,2-dialkoxy-ethanal and optionally a glyoxalate, said mixture having a molar ratio glyoxal/C₄₋₆ 2,2-dialkoxy-ethanal comprised between 1/1 and 10/1; and
   c. a protic acid catalyst;
2) preparing an oil-in-water dispersion, wherein the droplet size is comprised between 1 and 600 microns, and comprising:
   a. an oil;
   b. a water medium:
   c. at least an oligomeric composition as obtained in step 1;
   d. at least a cross-linker selected amongst:
      i. C₄-C₁₂ aromatic or aliphatic di- or tri-isocyanates and their biurets, triurets, trimmers, trimethylol propane-adduct and mixtures thereof; and/or
      ii. a di- or tri-oxiran compounds of formula:

A-(oxiran-2-ylmethy)ₙ
wherein ₙ stands for 2 or 3 and 1 represents a C₂-C₆ group optionally comprising from 2 to 6 nitrogen and/or oxygen atoms;
e. optionally a C₁-C₄ compounds comprising two NH₂ functional groups;
3) Heating the dispersion; and
4) Cooling the dispersion.

The above process is described in more details in International Patent Application Publication No. WO 2013/068255.

According to another aspect, the shell of the microcapsule is polyurea-or polyurethane-based. Examples of processes for the preparation of polyurea and polyureathane-based microcapsule slurry are for instance described in International Patent Application Publication No. WO2007/004166, European Patent Application Publication No. EP 2300146, and European Patent Application Publication No. EP25799. Typically a process for the preparation of polyurea or polyurethane-based microcapsule slurry include the following steps:
a) Dissolving at least one polyisocyanate having at least two isocyanate groups in an oil to form an oil phase;
b) Preparing an aqueous solution of an emulsifier or colloidal stabilizer to form a water phase;
c) Adding the oil phase to the water phase to form an oil-in-water dispersion, wherein the mean droplet size is comprised between 1 and 500 μm, preferably between 5 and 50 μm; and
d) Applying conditions sufficient to induce interfacial polymerisation and form microcapsules in form of a slurry.

According to a particular aspect of the invention, the microcapsule is coated with a polymer selected from the group consisting of a polysaccharide, a biopolymer, a cationic polymer and mixtures thereof to form an outer coating to the microcapsule.

Polysaccharide polymers are well known to a person skilled in the art. Examples of non-ionic polysaccharides include, but are not limited to the group consisting of locust bean gum, xyloglucan, guar gum, hydroxypropyl guar, hydroxypropyl cellulose and hydroxypropyl methyl cellulose, pectin and mixtures thereof.

According to a particular aspect, the coating consists of a cationic coating.

Cationic polymers are also well known to a person skilled in the art. In some aspects, cationic polymers have cationic charge densities of at least 0.5 meq/g, alternatively at least about 1.5 meq/g, alternatively less than about 7 meq/g, alternatively less than about 6.2 meq/g. The cationic charge density of the cationic polymers may be determined by the Kjeldahl method as described in the US Pharmacopoeia under chemical tests for Nitrogen determination. In some aspects, the cationic polymers are chosen from those that contain units comprising primary, secondary, tertiary and/or quaternary amine groups that can either form part of the main polymer chain or can be borne by a side substituent directly connected thereto. In some aspects, the weight average (Mw) molecular weight of the cationic polymer is between 10,000 and 3.5 M Dalton, alternatively between 50,000 and 2 M Dalton.

According to a particular aspect, one will use cationic polymers based on acrylamide, methacrylamide, N-vinylpyrrolidone, quaternized N,N-dimethylaminomethacrylate, diallyldimethylammonium chloride, quaternized vinylimidazole (3-methyl-1-vinyl-1H-imidazol-3-ium chloride), vinylpyrrolidone, acrylamidopropyltrimonium chloride, cassia hydroxypropyltrimonium chloride, guar hydroxypropyltrimonium chloride or polygalactomannan 2-hydroxypropyltrimethylammonium chloride ether, starch hydroxypropyltrimonium chloride and cellulose hydroxypropyltrimonium chloride. In some aspects, the copolymers shall be selected from the group consisting of polyquaternium-5, polyquaternium-6, polyquaternium-7, polyquaternium10, polyquaternium-11, polyquaternium-16, polyquaternium-22, polyquaternium-28, polyquaternium-43, polyquaternium-44, polyquaternium-46, cassia hydroxypropyltrimonium chloride, guar hydroxypropyltrimonium chloride or polygalactomannan 2-hydroxypropyltrimethylammonium chloride ether, starch hydroxypropyltrimonium chloride and cellulose hydroxypropyltrimonium chloride.

As specific examples of commercially available products, one may cite Salcare® SC60 (cationic copolymer of acrylamidopropyltrimonium chloride and acrylamide, origin: BASF) or Luviquat®, such as the PQ 11N, FC 550 or Style (polyquaternium-11 to 68 or quaternized copolymers of vinylpyrrolidone origin: BASF), or also the Jaguar® (C13S or C17, origin Rhodia).

According to any one of the above aspects, there is added an amount of polymer described above comprised between about 0% and 5% w/w, or even between about 0.1% and 2% w/w, percentage being expressed on a w/w basis relative to the total weight of the microcapsule slurry.

By “perfume oil” (or also “perfume”) what is meant here is an ingredient or composition that is a liquid at about 20° C. According to any one of the above aspects, the perfume oil can be a perfuming ingredient alone or a mixture of ingredients in the form of a perfuming composition. As a “perfuming ingredient” it is meant here a compound, which is used for the primary purpose of conferring or modulating an odor. In other words such an ingredient, to be considered as being a perfuming one, must be recognized by a person skilled in the art as being able to at least impart or modify in a positive or pleasant way the odor of a composition, and not just as having an odor. For the purpose of the present disclosure, perfume oil also includes combination of perfuming ingredients with substances which together improve, enhance or modify the delivery of the perfuming ingredients, such as perfume precursors, emulsions or dispersions, as well as combinations which impart an additional benefit beyond that of modifying or imparting an odor, such as long-lasting, blooming, malodor counteraction, antimicrobial effect, microbial stability, insect control.

The nature and type of the perfuming ingredients present in the hydrophobic internal phase do not warrant a more detailed description here, which in any case would not be exhaustive, the skilled person being able to select them on the basis of its general knowledge and according to intended use or application and the desired organoleptic effect. In general terms, these perfuming ingredients belong to chemical classes as varied as alcohols, aldehydes, ketones, esters, ethers, acetates, nitriles, terpenoids, nitrogenous or sulphurous heterocyclic compounds and essential oils, and the perfuming co-ingredients can be of natural or synthetic origin. Many of these co-ingredients are in any case listed in reference texts such as the book by S. Arctander, Perfume and Flavor Chemicals, 1969, Montclair, N.J., USA, or its more recent versions, or in other works of a similar nature, as well as in the abundant patent literature in the field of perfumery. It is also understood that the ingredients may also be compounds known to release in a controlled manner various types of perfuming compounds.

In particular one may cite perfuming ingredients which are commonly used in perfume formulations, such as:

Aldehydic ingredients: decanal, dodecanal, 2-methyl-undecanal, 10-undecenal, octanal, nonanal and/or nonenal;
Aromatic-herbal ingredients: eucalyptus oil, camphor, eucalyptol, 5-methyltricyclo[6.2.1.0˜2.7˜]undecan-4-one, 1-methoxy -3-hexanethiol, 2-ethyl-4,4-dimethyl-1,3-oxathiane, 2,2,7/8,9/10-Tetramethylspiro[5.5]undec-8-en-1-one, menthol and/or alpha-pinene;
Balsamic ingredients: coumarin, ethylvanillin and/or vanillin;
Citrus ingredients: dihydromyrcenol, citral, orange oil, linalyl acetate, citronellyl nitrile, orange terpenes, limonene, 1-p-menthen-8-yl acetate and/or 1,4(8)-p-menthadiene;
Floral ingredients: methyl dihydrojasmonate, linalool, citronellol, phenylethanol, 3-(4-tert-butylphenyl)-2-methylpropanal, hexylcinnamic aldehyde, benzyl acetate, benzyl salicylate, tetrahydro-2-isobutyl-4-methyl-4(2H)-pyranol, beta ionone, methyl 2-(methylamino)benzoate, (E)-3-methyl-4-(2,6,6-trimethyl-2-cyclohexen-1-yl)-3-buten-2-one, (1E)-1-(2,6,6-trimethyl-2-cyclohexen-1-yl)-1-penten-3-one, 1-(2,6,6-trimethyl-1,3-cyclohexadien-1-yl)-2-buten-1-one, (2E)-1-(2,6,6-trimethyl-2-cyclohexen-1-yl)-2-buten-1-one, (2E)-1-[2,6,6-trimethyl-3-cyclohexen-1-yl]-2-buten-1-one, (2E)-1-(2,6,6-trimethyl-1-cyclohexen-1-yl)-2-buten-1-one, 2,5-dimethyl-2-indanmethanol, 2,6,6-trimethyl-3-cyclohexene-2-carboxylate, 3-(4,4-dimethyl-1-cyclohexen-1-yl)propanal, hexyl salicylate, 3,7-dimethyl-1,6-nonadien-3-ol, 3-(4-isopropylphenyl)-2-methylpropanal, verdyl acetate, geraniol, p-menth-1-en-8-ol, 4-(1,1-dimethylethyl)-1-cyclohexyle acetate, 1,1-dimethyl-2-phenylethyl acetate, 4-cyclohexyl-2-methyl-2-butanol, amyl salicylate, high cis methyl dihydrojasmonate, 3-methyl-5-phenyl-1-pentanol, verdyl proprionate, geranyl acetate, tetrahydro linalool, cis-7-p-menthanol, propyl (S)-2-(1,1-dimethylpropoxy)propanoate, 2-methoxynaphthalene, 2,2,2-trichloro-1-phenylethyl acetate, 4/3-(4-hydroxy-4-methylpentyl)-3-cyclohexene-1-carbaldehyde, amylcinnamic aldehyde, 8-decen-5-olide, 4-phenyl-2-butanone, isononyle acetate, 4-(1,1-dimethylethyl)-1-cyclohexyl acetate, verdyl isobutyrate and/or mixture of methylionones isomers;
Fruity ingredients: gamma-undecalactone, 2,2,5-trimethyl-5-pentylcyclopentanone, 2-methyl-4-propyl-1,3-oxathiane, 4-decanolide, ethyl 2-methyl-pentanoate, hexyl acetate, ethyl 2-methylbutanoate, gamma-nonalactone, allyl heptanoate, 2-phenoxyethyl isobutyrate, ethyl 2-methyl-1,3-dioxolane-2-acetate, 3-(3,3/1,1-dimethyl-5-indanyl)propanal, diethyl 1,4-cyclohexanedicarboxylate, 3-methyl-2-hexen-1-yl acetate, 1-[3,3-dimethylcyclohexyl]ethyl [3-ethyl-2-oxiranyl]acetate and/or diethyl 1,4-cyclohexane dicarboxylate;
Green ingredients: 2-methyl-3-hexanone (E)-oxime, 2,4-dimethyl-3-cyclohexene-1-carbaldehyde, 2-tert-butyl-1-cyclohexyl acetate, styrallyl acetate, allyl (2-methylbutoxy)acetate, 4-methyl-3-decen-5-ol, diphenyl ether, (Z)-3-hexen-1-ol and/or 1-(5,5-dimethyl-1-cyclohexen-1-yl)-4-penten-1-one;
Musk ingredients: 1,4-dioxa-5,17-cycloheptadecanedione, (Z)-4-cyclopentadecen-1-one, 3-methylcyclopentadecanone, 1-oxa-12-cyclohexadecen-2-one, 1-oxa-13-cyclohexadecen-2-one, (9Z)-9-cycloheptadecen-1-one, 2-{1S)-1-[(1R)-3,3-dimethylcyclohexyl]ethoxyl}-2-oxoethyl propionate 3-methyl-5-cyclopentadecen-1-one, 1,3,4,6,7,8-hexahydro-4,6,6,7,8,8-hexamethyl-cyclopenta-g-2-benzopyrane, (1S, 1′R)-2-[1-(3′,3′-dimethyl-1′-cyclohexyl)ethoxy]-2-methylpropyl propanoate, oxacyclohexadecan-2-one and/or (1S,1′R)-[1-(3′,3′-dimethyl-1′-cyclohexyl)ethoxycarbonyl]methyl propanoate;
Woody ingredients: 1-[(1RS,6SR)-2,2,6-trimethylcyclohexyl]-3-hexanol, 3,3-dimethyl-5-[(1R)-2,2,3-trimethyl-3-cyclopenten-1-yl]-4-penten-2-ol, 3,4′-dimethylspiro[oxirane-2,9′-tricyclo[6.2.1.02.7]undec[4]ene, (1-ethoxyethoxy)cyclododecane, 2,2,9,11-tetramethylspiro[5.5]undec-8-en-1-yl acetate, 1-(octahydro-2,3,8,8-tetramethyl-2-naphtalenyl)-1-ethanone, patchouli oil, terpenes fractions of patchouli oil, clearwood®, (1′R,E)-2-ethyl-4-(2′,2′,3′-trimethyl-3′-cyclopenten-1′-yl)-2-buten-1-ol, 2-ethyl-4-(2,2,3-trimethyl-3-cyclopenten-1-yl)-2-buten-1-ol, methyl cedryl ketone, 5-(2,2,3-trimethyl-3-cyclopentenyl)-3-methylpentan-2-ol, 1-(2,3,8,8-tetramethyl-1,2,3,4,6,7,8,8a-octahydronaphthalen-2-yl)ethan-1-one and/or isobornyl acetate;
Other ingredients (e.g. amber, powdery spicy or watery): dodecahydro-3a,6,6,9a-tetramethyl-naphtho[2,1-b]furan and any of its stereoisomers, heliotropin, anisic aldehyde, eugenol, cinnamic aldehyde, clove oil, 3-(1,3-benzodioxo1-5-yl)-2-methylpropanal, 7-methyl-2H-1,5-benzodioxepin-3(4H)-one, 2,5,5-trimethyl-1,2,3,4,4a,5,6,7-octahydro-2-naphthalenol, 1-phenylvinyl acetate, 6-methyl-7-oxa-1-thia-4-azaspiro[4.4]nonan and/or 3-(3-isopropyl-1-phenyl)butanal.

A perfumery base according to the present disclosure may not be limited to the above mentioned perfuming ingredients, and many other of these co-ingredients are in any case listed in reference texts such as the book by S. Arctander, Perfume and Flavor Chemicals, 1969, Montclair, N.J., USA, or its more recent versions, or in other works of a similar nature, as well as in the abundant patent literature in the field of perfumery. It is also understood that said ingredients may also be compounds known to release in a controlled manner various types of perfuming compounds also known as properfume or profragrance. Non-limiting examples of suitable properfume may include 4-(dodecylthio)-4-(2,6,6-trimethyl-2-cyclohexen-1-yl)-2-butanone, 4-(dodecylthio)-4-(2,6,6-trimethyl-1-cyclohexen-1-yl)-2-butanone, trans-3-(dodecylthio)-1-(2,6,6-trimethyl-3-cyclohexen-1-yl)-1-butanone, 2-phenylethyl oxo(phenyl)acetate or a mixture thereof.

High impact perfumes: According to another embodiment, the oil phase (or the oil-based core) comprises:
25-100wt % of a perfume oil comprising at least 15wt % of high impact perfume raw materials having a Log T less than −4, and
0-75wt % of a density balancing material having a density greater than 1.07 g/cm³.

The nature of high impact perfume raw materials having a Log T<−4 and density balancing material having a density greater than 1.07 g/cm³ are described in WO2018115250, the content of which are included by reference.

The perfuming ingredients may be dissolved in a solvent of current use in the perfume industry. Examples of such solvents are diethyl phthalate, isopropyl myristate, Abalyn® (rosin resins, available from Eastman), benzyl benzoate, ethyl citrate, limonene or other terpenes, or isoparaffins. In one aspect, the solvent is very hydrophobic and highly sterically hindered, like for example Abalyn® or benzyl benzoate. In one aspect, the perfume comprises less than 30% of solvent. In an alternate aspect, the perfume comprises less than 20% and alternatively less than 10% of solvent, all these percentages being defined by weight relative to the total weight of the perfume. In one aspect, the perfume is essentially free of solvent.

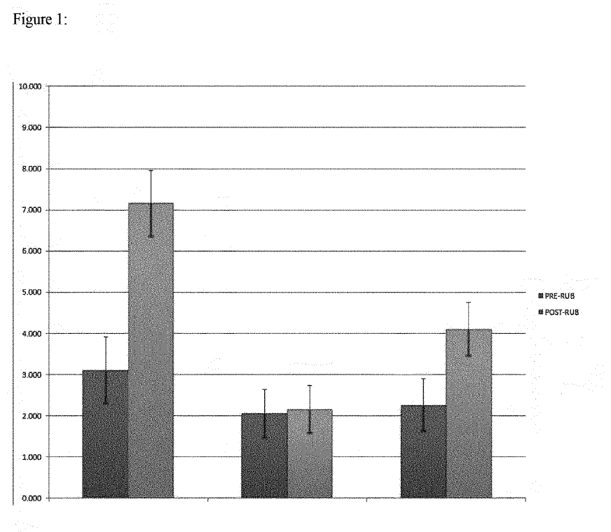

FIG. 1 shows the intensity of fragrance perceived by subjects in a sensory test panel from dryer sheets manufactured by a method according to an aspect presented herein, compared to the intensity of fragrance perceived by subjects in a sensory test panel from dryer sheets manufactured by a conventional method (commercially available dryer sheets).

The method according to an aspect presented herein comprised a flexographic printing method using an open channel, hex celled anilox roller having 17.2 billion cubic microns per square inch, wherein a slurry encapsulated fragrance is printed onto the non-woven and a molten quaternary ammonium salt was later applied to the unrolled portion of the webbing.

The present invention is best illustrated but is not limited to the following examples.

### EXAMPLES

### Example 1: Manufacture of a Dryer Sheet via a Method According to an Aspect Presented Herein

Printed dryer sheets were made using an APEX roller, 17.2 BCM, with a tension roller, no overprint, w/ink and a slurry of encapsulated fragrance oil (0.15% w/w encapsulated fragrance—Sample 1—left two columns—FIG. 1), using UV 400V, w/heated fan, blower blocked from tray. Printed sheets were then gently rolled with 1.5 g quat using the bath roller method. As a control, dryer sheets were treated with a commercially available encapsulate (0.4% w/w encapsulated fragrance 1—Sample 2—middle two columns—FIG. 1) premixed in quat, gently rolled onto sheet using the bath roller method. Finally, commercially available dryer sheets were included as an additional control—Sample 3 (right 2 columns—FIG. 1).

The performance of the printed dryer sheets was compared to the control and commercially available dryer sheets. The results are shown in FIG. 1. Points to note are that parity performance at pre-rub and significantly higher performance at post-rub was observed with dryer sheets made using composition according to aspects presented herein (Sample 1) with 16.7-37.5% of fragrance level on the printed sheet than Samples 2 and 3. Furthermore microscopy has shown that no capsules remain on the Sample 1 after use, i.e. 100% deposition, whereas Samples 2 and 3 still had visible capsules in the web, i.e. inefficient deposition.

### Example 2: Performance of a Dryer Sheet via a Method According to an Aspect Presented Herein

Separate perfume formulations were encapsulated via the following method: The oil phase was prepared by admixing a polyisocyanate (trimethylol propane adduct of xylylene diisocyanate, Takenate® D-110N, origin: Mitsui Chemicals) with a core oil composed of a perfume oil. The oil phase consisted of 2% Takenate® D-110N and 98% of core oil. After encapsulation and use of the Takenate® D-110N to cross-link the melamine-formaldehyde wall.

To make the capsule slurry, the acrylamide and acrylic acid copolymer and the blend of the two melamine-formaldehyde resins were dissolved in water to form the water phase. Then the perfume premix oil was added into this solution and the pH was regulated to 5 with acetic acid. The temperature was raised to 90° C. for 2 hours to allow the curing of the capsules. At this point, capsules were formed, cross-linked and stable. A 3% Salcare SC60 (acrylamidopropyltrimonium chloride/acrylamide copolymer) solution in water was then added into the mixture at 90° C. and was allowed to react for 1 hour at 90° C. Then a solution of ethylene urea (50% wt in water) was added as usually done with aminoplast capsules as an agent to scavenge residual free formaldehyde. Final slurry contains about 3% w/w of ethylene urea relative to the weight of the slurry and the mixture was left to cool down to room temperature. The final pH was adjusted to 7 with sodium hydroxide.

| | Capsules A |
|---|---|
| Ingredient | [%] |
| Oil Phase | 30.9 |
| Perfume oil | 30.28 |
| trimethylol propane adduct of xylylene | 0.62 |
| diisocyanate¹⁾ | |
| Water phase | 69.1 |
| Acrylamide and acrylic acid copolymer²⁾ | 4.7 |
| Melamine-formaldehyde resins ³⁾ | 2.45 ³⁾ |
| Water | 50.55 |
| Sodium hydroxide | 0.5 |
| Acetic acid | 0.2 |
| Acrylamidopropyltrimonium chloride/ | 10.7 |
| acrylamide copolymer ⁴⁾ | |
| Total | 100 |

¹⁾Takenate ® D110N (75% active solution in ethyl acetate)
²⁾Alcapsol from Ciba, 20% solution in water
³⁾ 90/10 blend of Cymel 385 & Cymel 9370 from Cytec, both 70% solution in water
⁴⁾ Salcare SC60 from Ciba, 3% solution in water

Different perfume compositions were encapsulated separately: perfume oil A (see table 1), perfume oil B (see table 2), and perfume oil C (see table 3). The encapsulated perfume compositions were added to separate dryer sheets. The test dryer sheets were sized to have an effective capsule dosage of 1.38% in 1.5 g of esterquat. Softening agent was added to the dryer sheets with perfume oil D at a concentration of 3.00%. This free oil/encapsulated oil dosage matches latest known oil levels in commercially available dryer sheets. A load of 32 13″×13″ cotton washcloths was washed in a Maytag stackable washer/dryer with a 64 ltr drum capacity. One sheet was added to each load for the dry cycle which was run on normal heat for 50 minutes.

TABLE 1
Perfume oil A composition

| INGREDIENTS | % |
|---|---|
| ETHYL 2-METHYLBUTANOATE | 1.7 |
| 3-(3-HYDROXYPROPOXY)PROPAN-1-OL | 6.2 |
| 2,4-IVY CARBALDEHYDE | 1.0 |
| METHYL BENZOATE (METHYL BENZOATE) | 1.2 |
| TETRAHYDROMYRCENOL (2,6-DIMETHYL-2-OCTANOL) | 1.7 |
| 4-METHYL-2-(2-METHYLPROP-1-ENYL)OXANE | 1.4 |
| 4-METHYL-2-(2-METHYLPROPYL)OXAN-4-OL | 1.3 |
| CITRONELLYL NITRILE ((−)-(R)-3,7-DIMETHYL- | 5.5 |
| 6-OCTENENITRILE) | |
| CUMINIC ALDEHYDE (4-ISOPROPYLBENZALDEHYDE) | 0.1 |
| 10-UNDECENAL | 1.4 |
| METHYL ANTHRANILATE (BENZOIC ACID, 2-AMINO-, | 0.5 |
| METHYL ESTER) | |
| 4-TERT-BUTYL-1-CYCLOHEXYL ACETATE | 11.1 |
| (4-ALLYL-2-METHOXYPHENOL | 1.5 |
| ALDEHYDE MNA ((+−)-2-METHYLUNDECANAL) | 2.8 |
| 2-BUTEN-1-ONE, 1-(2,6,6-TRIMETHYL-1,3-CYCLO- | 0.6 |
| HEXADIENYL) | |
| DIPHENYL ETHER | 5.6 |
| DODECANAL | 2.1 |
| 2-CHROMENONE | 2.8 |
| 3A,4,5,6,7,7A-HEXAHYDRO-4,7-METHANOINDEN- | 7.3 |
| 6-YL ACETATE | |
| 3-BUTEN-2-ONE, 4-(2,6,6-TRIMETHYL-2-CYCLO- | 4.8 |
| HEXEN-1-YL) | |
| 2-METHOXYNAPHTHALENE | 4.0 |
| ETHYL (E)-3-PHENYL-2-PROPENOATE | 2.8 |
| 1-(5,5-DIMETHYL-1-CYCLOHEX-2-ENYL)PENT-4- | 0.2 |
| EN-1-ONE | |
| (1S)-1,2,3,4,5,6,7,8-OCTAHYDRO-7BETA-ISO- | 0.4 |
| PROPENYL-1BETA,4BETA-DIMETHYL AZULENE | |
| (1R,3S,6S)-3,6,8-TRIMETHYL-2-METHYLENE- | 0.2 |
| TRICYCLO[5.3.1.0(3,8)]UNDECANE | |
| (+−)-2,5-DIMETHYL-2-INDANMETHANOL | 0.5 |
| 3-BUTEN-2-ONE, 4-(2,6,6-TRIMETHYL-1- | 1.3 |
| CYCLOHEXEN-1-YL) | |
| 2,6,10-DODECATRIEN-1-OL, 3,7,11-TRIMETHYL | 0.1 |
| (1S)-1,2,3,4,5,6,7,8-OCTAHYDRO-7BETA-ISO- | 0.1 |
| PROPENYL-1BETA,4BETA-DIMETHYLAZULENE | |
| (3S)-1,2,3,3A,4,5,6,7-OCTAHYDRO-5BETA-ISO- | 0.5 |
| PROPENYL-3BETA,8-DIMETHYL-3AALPHA-AZULENE | |
| (+−)-4-UNDECANOLIDE) | 1.2 |
| (E)-2-ETHYL-4-(2,2,3-TRIMETHYL-1-CYCLOPENT- | 2.9 |
| 3-ENYL)BUT-2-EN-1-OL | |
| (Z)-1,2,4-TRIMETHOXY-5-(1-PROPENYL)BENZENE | 0.1 |
| 6-BUTAN-2-YLQUINOLINE | 0.4 |
| ETHANONE, 1-(OCTAHYDRO-TETRAMETHYL-2- | 4.6 |
| NAPTHALENYL) | |
| 1-(OCTAHYDRO-1,2,8,8-TETRAMETHYL-2- | 3.3 |
| NAPHTHALEN-2-YL)-1-ETHANONE) | |
| METHYL 2,4-DIHYDROXY-3,6-DIMETHYLBENZOATE | 1.0 |
| CYCLOHEXYL 2-HYDROXYBENZOATE | 0.9 |
| ETHANONE, 1-(OCTAHYDRO-TETRAMETHYL-2- | 0.1 |
| NAPTHALENYL) | |
| 13-OXABICYCLO[10.4.0]HEXADEC-1(12)-ENE | 0.6 |
| (+−)-8,12-EPOXY-13,14,15,16-TETRA- | 0.3 |
| NORLABDANE | |
| (12E)-1-OXACYCLOHEXADEC-12-EN-2-ONE | 13.2 |
| 16-OXACYCLOHEXADECAN-1-ONE | 0.7 |

TABLE 2
Perfume oil B composition

| INGREDIENT | % |
|---|---|
| ETHYL 2-METHYLBUTANOATE | 3.2 |
| 6-METHYL-5-HEPTEN-2-ONE | 0.3 |
| OCTANAL | 2.2 |
| 5-HEPTENAL, 2,6-DIMETHYL | 1.6 |
| 2,4-IVY CARBALDEHYDE | 5.5 |
| (+−)-3,7-DIMETHYLOCTANAL | 0.6 |
| (Z)-3,4,5,6,6-PENTAMETHYLHEPT-3-EN-2-ONE | 4.5 |
| PROP-2-ENYL 2-(3-METHYLBUTOXY)ACETATE | 4.4 |
| (+)-(4R)-1-P-MENTHENE-9-CARBALDEHYDE | 2.1 |
| METHYL N-METHYLANTHRANILATE | 1.1 |
| (+−)-2-METHYLUNDECANAL | 5.7 |
| (Z)-4-DODECENAL | 0.4 |
| 3A,4,5,6,7,7A-HEXAHYDRO-4,7-METHANOINDEN-6-YL | 9.3 |
| ACETATE | |
| 3-(4-ETHYLPHENYL)-2,2-DIMETHYLPROPANAL | 7.7 |
| 2-METHOXYNAPHTHALENE | 6.7 |
| 1-(5,5-DIMETHYL-1-CYCLOHEX-2-ENYL)PENT-4-EN-1-ONE | 0.9 |
| 3-BUTEN-2-ONE, 4-(2,6,6-TRIMETHYL-1-CYCLOHEXEN- | 3.3 |
| 1-YL) | |
| (+−)-4-UNDECANOLIDE | 8.3 |
| ETHANONE, 1-(OCTAHYDRO-TETRAMETHYL-2- | 10.5 |
| NAPTHALENYL) | |
| HEXYL 2-HYDROXYBENZOATE | 13.3 |
| 1-(OCTAHYDRO-1,2,8,8-TETRAMETHYL-2-NAPHTHALEN-2- | 6.9 |
| YL)-1-ETHANONE) | |
| CYCLOHEXANEPROPANOL, 2,2,3,6-TETRAMETHYL- | 1.5 |
| .ALPHA.-PROPYL- | |

TABLE 3
Perfume oil C composition

| NAME | % |
|---|---|
| 2,4-IVY CARBALDEHYDE | 0.4 |
| 4-METHYL-2-(2-METHYLPROP-1-ENYL)OXANE | 0.6 |
| ACETIC ACID, PHENYLMETHYL ESTER | 4.1 |
| 1-PHENYLETHYL ACETATE | 0.5 |
| (−)-PROPYL (S)-2-(1,1-DIMETHYLPROPOXY)PRO- | 3.4 |
| PANOATE | |
| 4-CYCLOHEXYL-2-METHYL-2-BUTANOL | 1.2 |
| (2-TERT-BUTYLCYCLOHEXYL) ACETATE | 3.3 |
| BENZENEETHANOL, 1,1-DIMETHYL, ACETATE | 0.7 |
| METHYL N-METHYLANTHRANILATE | 1.5 |
| ACETIC ACID, 3,7-DIMETHYL-6-OCTENYL ESTER | 3 |
| TRANS-4-TERT-BUTYL-1-CYCLOHEXYL ACETATE | 6.8 |
| 2-BUTEN-1-ONE, 1-(2,6,6-TRIMETHYL-3-CYCLO- | 1.7 |
| HEXENYL | |
| 2-CHROMENONE | 1.1 |
| 3A,4,5,6,7,7A-HEXAHYDRO-4,7-METHANOINDEN- | 6.3 |
| 6-YL ACETATE | |
| PROP-2-ENYL 2-(PHENOXY)ACETATE | 0.2 |
| 2-METHOXYNAPHTHALENE | 2.7 |
| (1S)-1,2,3,4,5,6,7,8-OCTAHYDRO-7BETA-ISO- | 0.5 |
| PROPENYL-1BETA,4BETA-DIMETHYL AZULENE | |
| (1R,3S,6S)-3,6,8-TRIMETHYL-2-METHYLENE- | 0.2 |
| TRICYCLO[5.3.1.0(3,8)]UNDECANE | |
| (+−)-(E)-3-METHYL-4-(2,6,6-TRIMETHYL- | 4 |
| 2-CYCLOHEXEN-1-YL)-3-BUTEN-2-ONE | |
| 2-METHYL-4-(2,6,6-TRIMETHYL-1-CYCLOHEXEN-1- | 0.1 |
| YL)-2-BUTENAL | |
| 2-PHENOXYETHYL ISOBUTYRATE | 0.6 |
| (E)-3-METHYL-4-(2,6,6-TRIMETHYL-1-CYCLOHEX- | 1.4 |
| ENYL)BUT-3-EN-2-ONE | |
| PROPANAL, 2-METHYL-3-(4-TERBUTYL-1-PHENYL | 9 |
| (3S)-1,2,3,3A,4,5,6,7-OCTAHYDRO-5BETA-ISO- | 0.5 |
| PROPENYL-3BETA,8-DIMETHYL-3AALPHA-AZULENE | |
| 2-METHYLBUTYL SALICYLATE | 2.2 |
| (+−)-4-UNDECANOLIDE | 2.1 |
| PENTYL 2-HYDROXYBENZOATE | 3.7 |
| 1-(2-NAPHTHALENYL)-1-ETHANONE | 10 |
| (E)-2-PENTYL-3-PHENYL-2-PROPENAL | 0.2 |
| (+−)-METHYL CIS-3-OXO-2-PENTYL-1-CYCLO- | 1.6 |
| PENTANEACETATE | |
| ETHANONE, 1-(OCTAHYDRO-TETRAMETHYL-2- | 5.6 |
| NAPTHALENYL) | |
| 1-(OCTAHYDRO-1,2,8,8-TETRAMETHYL-2-NAPHTHALEN- | 2.2 |
| 2-YL)-1-ETHANONE) | |
| METHYL 2,4-DIHYDROXY-3,6-DIMETHYLBENZOATE | 0.1 |
| CYCLOHEXANEPROPANOL, 2,2,3,6-TETRAMETHYL- | 0.3 |
| ALPHA-PROPYL- | |
| 2-HEXYL-3-PHENYL-2-PROPENAL | 6.6 |
| CYCLOHEXYLIDENE(PHENYL)ACETONITRILE | 5.1 |
| 13-OXABICYCLO[10.4.0]HEXADEC-1(12)-ENE | 0.2 |
| (12E)-1-OXACYCLOHEXADEC-12-EN-2-ONE | 6 |
| 16-OXACYCLOHEXADECAN-1-ONE | 0.3 |

Samples were blind coded. Panelists were instructed to evaluate towels in a randomized order. They rated each sample for pre-rub intensity. Panelists were then instructed to rub the towels and rate for post-rub intensity.

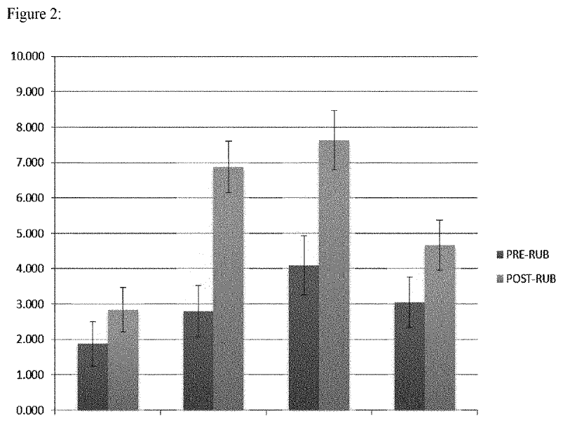

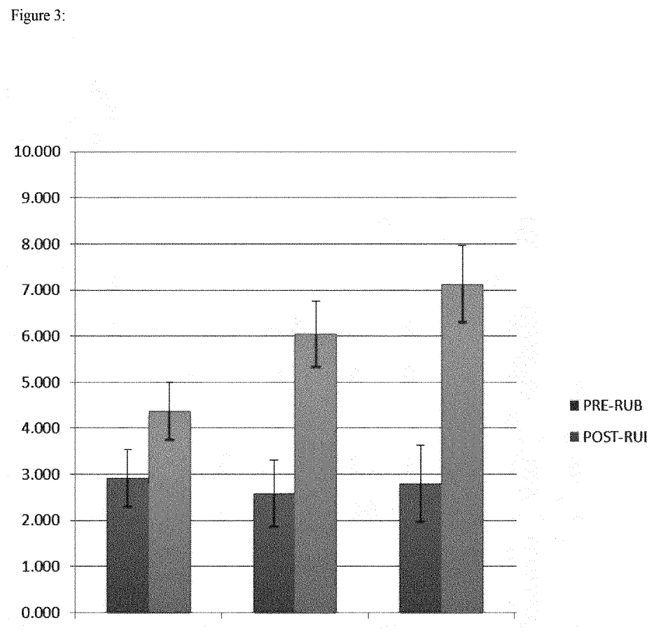

Scale was 0-10, with 0 being no fragrance, 5 being moderate fragrance, and 10 being very strong fragrance. The results are shown in FIGS. 2 and 3.

Dryer sheets comprising microcapsules containing perfume oil A, perfume oil B, and perfume oil C were found to have significantly better post-rub performance compared to a single commercially available dryer sheet. Dryer sheets comprising encapsulated perfume oil C were found to have significantly better performance during pre-rub. Furthermore, the change in perceived strength was larger for microcapsules containing perfume oil A, and perfume oil B, compared to the commercially available dryer sheets. Against the commercially available dryer sheets, post-rub performance was still significantly better for microcapsules containing perfume oil A, and perfume oil B.

### Example 3: Performance of a Dryer Sheet via a Method According to an Aspect Presented Herein—ANOVA Testing

Samples were made with (i) microcapsules containing perfume B at a concentration of 1.38%, with non-encapsulated a softening agent at a concentration of 3.0% (effective dose in 1.5 g esterquat) (Sample 1) and (i) microcapsules containing perfume A at a concentration of 1.38%, with a non-encapsulated softening agent at a concentration of 3.0% (effective dose in 1.5 g esterquat) (Sample 2), using the traditional “bath” and “spray” methods of dryer sheet application. The microcapsules were stirred into molten quat which was then rolled onto non-woven, over a hot plate. The softening agent was added by spraying from an aerosol bottle. The wash/dry method was the same as described in Example 2 above. Data was scored using a 3-cell ANOVA. Commercially available dryer sheets were included as control (Control). The results are shown below.

| Pre-Rub | Intensity | Post-Rub | Intensity | Pre-Rub | Intensity | Post-Rub | Intensity |
|---|---|---|---|---|---|---|---|
| Sample 1 | 3.192 | Sample 1 | 6.923 | Sample 2 | 3.033 | Sample 2 | 6.667 |
| PRINTED | | PRINTED | | PRINTED | | PRINTED | |
| Sample 1 | 3.077 | Sample 1 | 4.423 | Sample 2 | 2.167 | Sample 2 | 5.000 |
| SPRAY | | SPRAY | | SPRAY | | SPRAY | |
| CONTROL | 1.885 | CONTROL | 2.808 | CONTROL | 1.8 | CONTROL | 2.167 |
| PR > F | 0.014 | PR > F | <0.0001 | PR > F | 0.002 | PR > F | <0.0001 |
| (Model) | | (Model) | | (Model) | | (Model) | |
| Significant | YES | Significant | YES | Significant | YES | Significant | YES |

Sample 2 applied via printing was found to be statistically significantly more intense at both pre and post rub stages. During pre-rub stage, Sample 2 applied via bath process and benchmark were found to have statistical parity. In post-rub, Sample 2 applied via bath was found to be statistically significantly more intense than benchmark. This suggests that both the fragrance system and the method of application improve performance when compared to a commercially available dryer sheet.

Sample 1 applied via print was found to be statistically significantly more intense at both pre and post rub stages. During pre-rub stage, Sample 1 applied via bath process and benchmark were found to be statistically significantly more intense than benchmark. In post-rub, Sample 1 applied via bath was also found to be statistically significantly more intense than benchmark. This suggests that both the fragrance system and the method of application improve performance when compared to a commercially available dryer sheet.

The goal of ANOVA testing was to show that the print process creates stronger intensity than traditional bath process.

### Example 4: Microscopic Analysis of a Dryer Sheet via a Method According to an Aspect Presented Herein, Compared to a Commercially Available Dryer Sheet

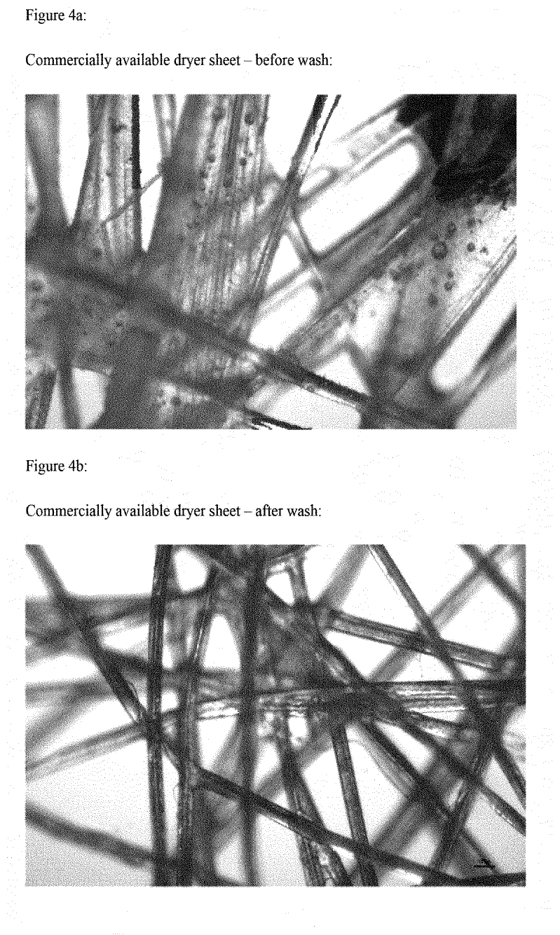

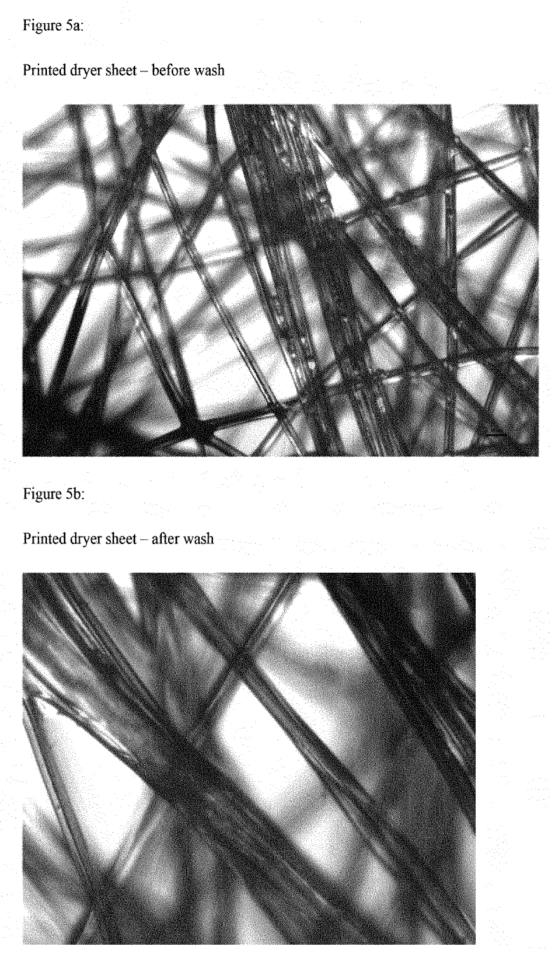

Samples of printed dryer sheets were made according to the methods described above. A small mark was made on the sheet, using a black marker, in an attempt to photograph the same area of nonwoven both before and after washing. Due to the relatively large depth of the sheet (about 5 mil, or 0.127 mm), a number of pictures were taken at various levels of focus. The wash/dry method was the same as described in Example 2 above. The results for the commercially available dryer sheet are shown in FIG. 4. The results for a printed dryer sheets were made according to the methods described above are shown in FIG. 5.

Referring to FIG. 4, after washing, large clusters of wax and capsule can still be seen, especially where multiple threads come together. In contrast, referring to FIG. 5, wax and capsules were not visible.

### Example 5: Effect of Microcapsule Thickness and Degree of Cross-Linking on the Performance of a Dryer Sheet via a Method According to an Aspect Presented Herein

Referring to the table below, a perfume oil was encapsulated into a microcapsule having a thinner wall than the capsules described in the examples above. The targeted dose per sheet was about 1.00% but the amount remaining after application was considerably less, in most cases hovering around 0.02%. Due to the stability of the remaining capsules, these data suggest that the vast majority of the capsules either didn't deposit in the first place or were destroyed during application.

| | Mg of encapsulated | | | Effective | | |
|---|---|---|---|---|---|---|
| | fragrance per 2 sheets | | | remaining % dosage | | |
| | 1 | 3 | 6 | 1 | 3 | 6 |
| Sample | week | weeks | weeks | week | weeks | weeks |
| Fragrance 13-mil | 1.5 | 1.1 | 1.6 | 0.075 | 0.055 | 0.080 |
| Fragrance 14-mil | 1.3 | 1.5 | 1.5 | 0.065 | 0.075 | 0.075 |
| Fragrance 15-mil | 0.9 | 0.9 | 1.2 | 0.045 | 0.045 | 0.060 |

Publications cited throughout this document are hereby incorporated by reference in their entirety. Although the various aspects of the invention have been illustrated above by reference to examples and preferred embodiments, it will be appreciated that the scope of the invention is defined not by the foregoing description but by the following claims properly construed under principles of patent law.

1. An article of manufacture, wherein the article of manufacture comprises:
a) a substrate comprising a webbing; and
b) a varnish layer comprising an encapsulated fragrance composition applied to at least one surface of the substrate.

2. The article of manufacture of claim 1, wherein the encapsulated fragrance composition is encapsulated in aminoplast-based microcapsules.

3. The article of manufacture of claim 1, wherein the article of manufacture further comprises a protective overprint layer on top of the varnish layer.

4. The article of manufacture of claim 1, wherein the article of manufacture further comprises at least one agent selected from the group consisting of: at least one anti-static agent, at least one dye transfer inhibitor, at least one whitening agent, at least one enzyme, at least one stain repellent, at least one wrinkle reducing agent, and at least one fabric softener agent.

5. The article of manufacture of claim 1, wherein the substrate comprises a non-woven webbing.

6. The article of manufacture of claim 1, wherein the article of manufacture is a dryer sheet.

7. The article of manufacture of claim 1, wherein the article of manufacture is a wipe.

8. A method for manufacturing the article as defined in claim 1, comprising the steps of:
a) providing a rolled substrate comprising a webbing;
b) unrolling a portion of the substrate; and
c) applying a varnish comprising an encapsulated fragrance composition to the unrolled portion of the substrate in a first coating step.

9. The method according to claim 8, further comprising a step of adding at least one agent selected from the group consisting of: at least one anti-static agent, at least one dye transfer inhibitor, at least one whitening agent, at least one enzyme, at least one stain repellent, at least one wrinkle reducing agent, and at least one fabric softener agent to the unrolled portion of the substrate in a subsequent coating step.

10. The method according to claim 9, further comprising a step of adding a protective overprint layer on top of the varnish layer in a subsequent coating step.
